(19) United States
(12) Patent Application Publication
(10) Pub. No.: US 2012/0194411 A1
(43) Pub. Date: Aug. 2, 2012

(54) RADIO APPARATUS, DISPLAY APPARATUS AND RECEPTION CONTROL METHOD

(75) Inventor: Takeshi Tajima, Ome-shi (JP)

(73) Assignee: KABUSHIKI KAISHA TOSHIBA, Tokyo (JP)

(21) Appl. No.: 13/360,587

(22) Filed: Jan. 27, 2012

(30) Foreign Application Priority Data
Jan. 31, 2011 (JP) 2011-019223

(51) Int. Cl. G09G 5/00

(52) U.S. Cl. 345/2.3

(57) ABSTRACT

A radio apparatus includes a first receiving module, a connection module, a register module, a selection module and a second receiving module. The first receiving module is configured to receive a plurality of connection requests, each transmitted wirelessly from each of a plurality of external apparatuses. The connection module is configured to establish a plurality of communication connections with the external apparatuses by sending permission responses to the external apparatuses in response to the connection requests. The register module is configured to register the external apparatuses in chronological order of establishment of each of the communication connections. The selection module is configured to select an external apparatus according to the chronological order. The second receiving module is configured to receive image data that is transmitted from the selected external apparatus.

### CROSS REFERENCE TO RELATED APPLICATION(S)

The present disclosure relates to the subject matters contained in Japanese Patent Application No. 2011-019223 filed on Jan. 31, 2011, which are incorporated herein by reference in its entirety.

### FIELD

An embodiment of the present invention relates to a radio apparatus, a display apparatus and a reception control method.

### BACKGROUND

A technique is known that a radio apparatus connected to a display device receives image data that is transmitted wirelessly from an image output apparatus such as a PC and the display device displays the image data received by the radio apparatus. In this technique, the image output apparatus sends an image output permission request to the radio apparatus and sends image data to the radio apparatus by a one-to-one wireless communication upon reception of a permission response to the request.

To send image data to the radio apparatus from a second image output apparatus while a first image output apparatus is sending image data to the radio apparatus, the user needs to perform a manipulation for sending an image output permission request after recognizing the end of the image data transmission from the first image output apparatus. Therefore, the switching between the image output apparatus may be cumbersome to the user.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 illustrates an example use form of a wireless system according to an embodiment.

FIG. 2 shows example system configurations of a display apparatus, the radio apparatus and a computer according to the embodiment.

FIG. 3 shows an example data structure of a waiting list which is generated by the radio apparatus according to the embodiment.

FIGS. 4A and 4B show example pictures which are displayed by the display apparatus and each computer according to the embodiment, respectively.

FIG. 5 is an exemplary sequence diagram of image data transmitting/receiving operations of the radio apparatus and computers according to the embodiment.

FIG. 6 is an exemplary flowchart of a image data transmission process which is performed by a computer according to the embodiment.

FIG. 7 is an exemplary flowchart of a image data reception process which is performed by the radio apparatus according to the embodiment.

### DETAILED DESCRIPTION OF THE EMBODIMENTS

According to an embodiment, there is provided a radio apparatus includes a first receiving module, a connection module, a register module, a selection module and a second receiving module. The first receiving module is configured to receive a plurality of connection requests, each transmitted wirelessly from each of a plurality of external apparatuses. The connection module is configured to establish a plurality of communication connections with the external apparatuses by sending permission responses to the external apparatuses in response to the connection requests. The register module is configured to register the external apparatuses in chronological order of establishment of each of the communication connections. The selection module is configured to select an external apparatus according to the chronological order. The second receiving module is configured to receive image data that is transmitted from the selected external apparatus.

An exemplary embodiment will be hereinafter described with reference to the drawings.

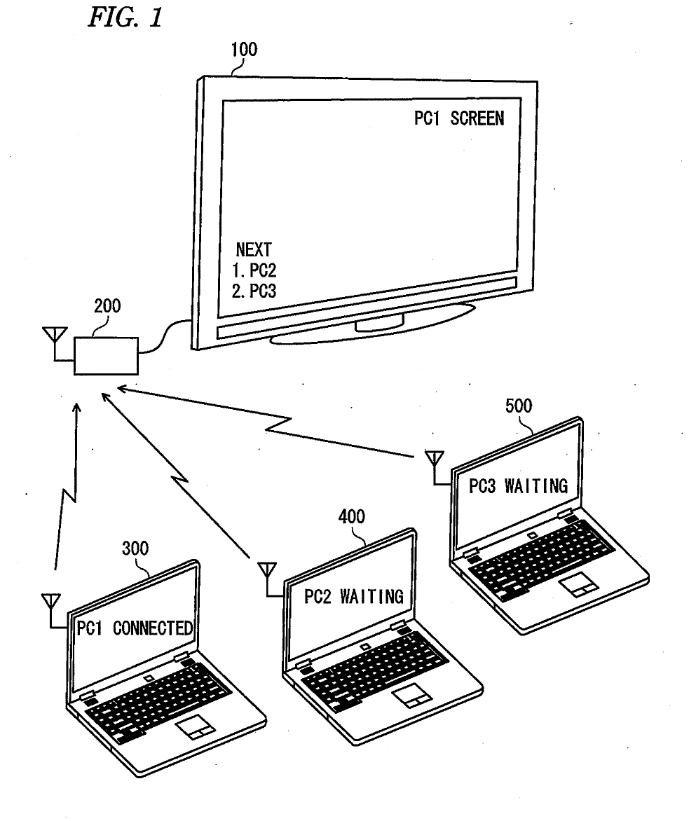

FIG. 1 illustrates an example use form of a wireless system according to the embodiment. The wireless system according to the embodiment consists of a display apparatus 100, a radio apparatus 200, and computers 300, 400, and 500, etc. The display apparatus 100 and the radio apparatus 200 are connected to each other by a wired or wireless digital interface of HDMI or the like.

Equipped with a display module 103, the display apparatus 100 has a function of displaying, on the display module 103, an image of image data that is output from the radio apparatus 200. The radio apparatus 200 establishes a wireless communication with each of the computers 300 to 500 by sending a permission response in response to a connection request that is sent from each of the computers 300 to 500. Then, the radio apparatus 200 permits transmission of image data from a computer with which a wireless communication has been established by sending a permission response in response to an image output permission request sent from the computer. However, when the radio apparatus 200 has received image output permission requests from plural computers, the radio apparatus 200 sends a permission response to one of the plural computers. That is, the radio apparatus 200 receives image data from one computer.

Each of the computers 300 to 500 sends a connection request to the radio apparatus 200 and establishes a connection with the radio apparatus 200 when receiving a permission response in response to the connection request. Each of the computers 300 to 500 sends image data to the radio apparatus 200 when receiving a permission response to an image output permission request that has been sent to the radio apparatus 200 in a wireless-communication-established state.

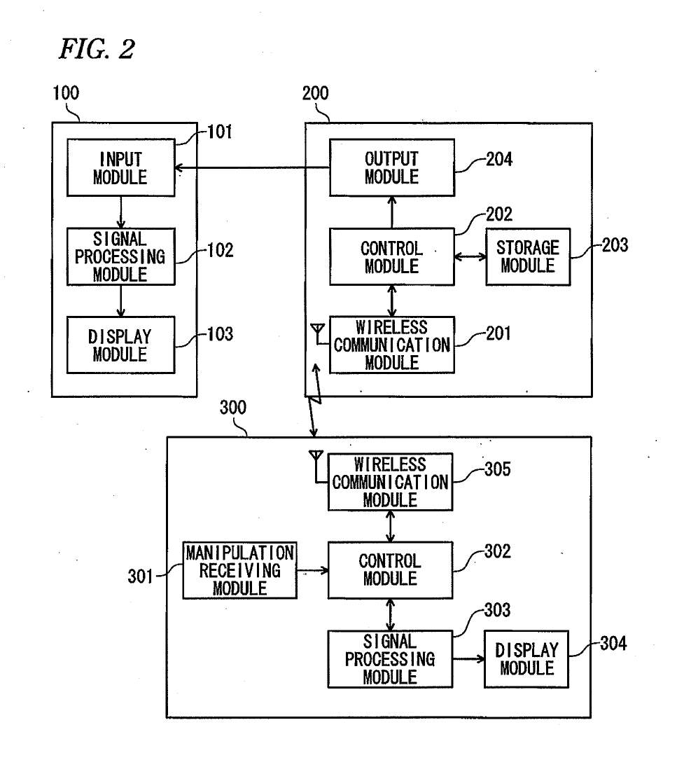

The radio apparatus according to the embodiment makes it possible to easily switch the computer for which transmission of image data should be permitted in a situation that the radio apparatus 200 has received image output permission requests from plural computers. How this function is implemented will be described later in detail with reference to FIGS. 2 to 7.

FIG. 2 shows example sets of function blocks of the display apparatus 100, the radio apparatus 200, and the computer 300. The function blocks of each of the computers 400 and 500 are the same as those of the computer 300 and hence will not be described below.

The display apparatus 100 is equipped with an input module 101, a signal processing module 102, the display module 103, etc. The input module 101 receives image data etc. from the radio apparatus 200 which is connected to the input module 101 by wire or wirelessly. The signal processing module 102 converts the image data received at the input module 101 into an image signal for display. The display module 103 displays an image using the image signal.

The radio apparatus 200 is equipped with a wireless communication module 201, a control module 202, a storage module 203, an output module 204, etc. The wireless communication module 201 sends and receives data to and from the computer 300 by a wireless communication. For example, the wireless communication module 201 receives a communication connection request, a communication disconnection request, an image output permission request, image data, etc. from the computer 300 and outputs a received request or data to the control module 202.

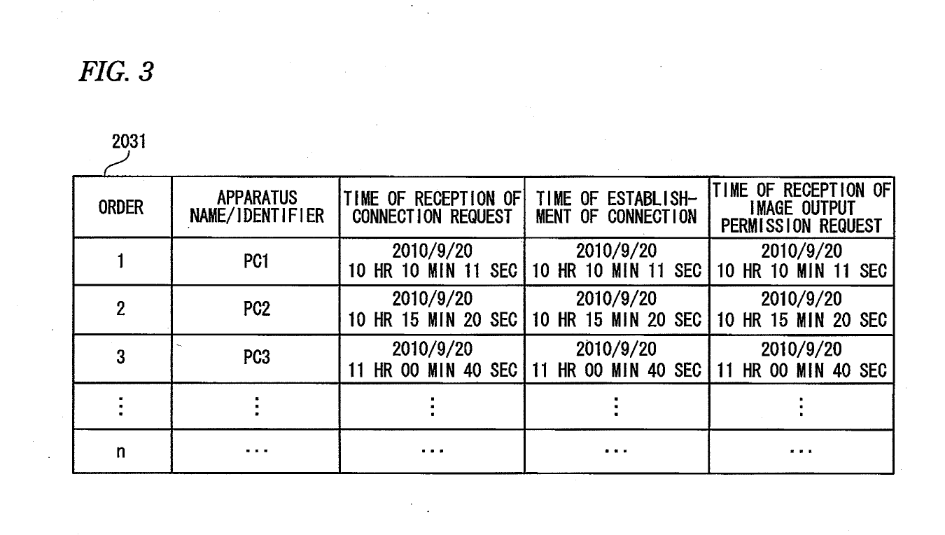

The control module 202 controls the individual modules of the radio apparatus 200. When receiving a connection request from the wireless communication module 201, the control module 202 determines whether or not the number of computers from which connection requests were sent is smaller than or equal to a certain number. For example, the certain number is the number of computers that can be connected to the radio apparatus 200 simultaneously. When the number of connection requests received is smaller than or equal to the certain number, the control module 202 establishes wireless connections to computers that have sent the connection requests by sending permission responses to the received connection requests, and generates a waiting list 2031. For example, the waiting list 2031 is a list in which apparatus names or identifiers of computers from which the connection requests were sent are registered in chronological order of establishment of wireless connections or in chronological order of reception of connection requests. The waiting list 2031 will be described later with reference to FIG. 3.

The control module 202 outputs the waiting list 2031 to the storage module 203 to store the waiting list 2031 therein. To add the apparatus name or identifier of a next computer to the waiting list 2031, the control module 202 reads the waiting list 2031 from the storage module 203 and updates it. When the number of computers from which connection requests were sent has become larger than the certain number, the control module 202 controls the wireless communication module 201 to send a connection refusal response.

When receiving a disconnection request from the wireless communication module 201, the control module 202 updates the waiting list 2031 by deleting the computer that has sent the disconnection request from the waiting list 2031 and raising the positions (orders) of the remaining computers in the waiting list 2031.

When receiving an image output permission request from the wireless communication module 201, the control module 202 determines where the computer that has sent the image output permission request stands in the waiting list 2031. When the computer concerned is at the head of the waiting list 2031, the control module 202 sends an image output permission response to the computer. When the computer concerned is not at the head of the waiting list 2031, the control module 202 sends the computer concerned information indicating its position in the waiting list 2031 (an order of the computer concerned among the chronological order).

When receiving image data from the wireless communication module 201, the control module 202 causes the output module 204 to output the received image data. The control module 202 generates data of an image that conforms to the contents of the waiting list 2031 and causes the output module 204 to output the generated image data. Where the control module 202 is receiving image data from the wireless communication module 201, the control module 202 superimposes the generated image data on the image data being received and causes the output module 204 to output resulting image data.

The computer 300 is equipped with a manipulation receiving module 301, a control module 302, a signal processing module 303, a display module 304, and a wireless communication module 305. The manipulation receiving module 301 receives a manipulation input from the user.

The control module 302 controls the individual modules of the computer 300. The control module runs one of various pieces of software according to a manipulation input received from the manipulation receiving module 301, and generates data of an image corresponding to an execution state of the software. When receiving waiting information from the wireless communication module 305, the control module 302 generates data of an image corresponding to the received waiting information and outputs the generated image data to the signal processing module 303. The signal processing module 303 converts the received image data into an image signal, and the display module 304 displays an image corresponding to the image signal.

The control module 302 controls the wireless communication module 305 to send a communication connection request, a communication disconnection request, or an image output permission request to the radio apparatus 200 according to a manipulation input from the user. The control module 302 can send a communication connection request, a communication disconnection request, or an image output permission request in such a manner that the request contains the apparatus name or the identifier of the computer 300. When receiving a connection permission response in response to the communication connection request, the control module 302 establishes a wireless communication with the radio apparatus 200. When receiving an output permission response in response to the image output permission request, the control module 302 can send image data to the wireless apparatus 200.

Next, an example data structure of the waiting list 2031 which is generated by the radio apparatus 200 will be described with reference to FIG. 3. In the waiting list 2031, apparatus names or identifiers are arranged according to times of reception, by the radio apparatus 200, of connection requests sent from computers having those apparatus names or identifiers. The radio apparatus 200 sends an image output permission response to the computer that stands at the head of the waiting list 2031. When receiving a communication disconnection request from a computer whose apparatus name or identifier is contained in the waiting list 2031, the radio apparatus 200 updates the positions of the computers in the waiting list 2031 by deleting the apparatus name or identifier of that computer from the waiting list 2031. That is, when receiving a communication disconnection request from, for example, the computer PC1, the radio apparatus 200 deletes the computer PC1 from the waiting list 2031 and raising the positions of the computers PC2 and PC3 to the first position and the second position, respectively. In the waiting list 2031, apparatus names or identifiers may be arranged according to times of establishment of wireless communications between the radio apparatus 200 and computers having those apparatus names or identifiers or times of reception, by the radio apparatus 200, of image output permission requests sent from computers having those apparatus names or identifiers.

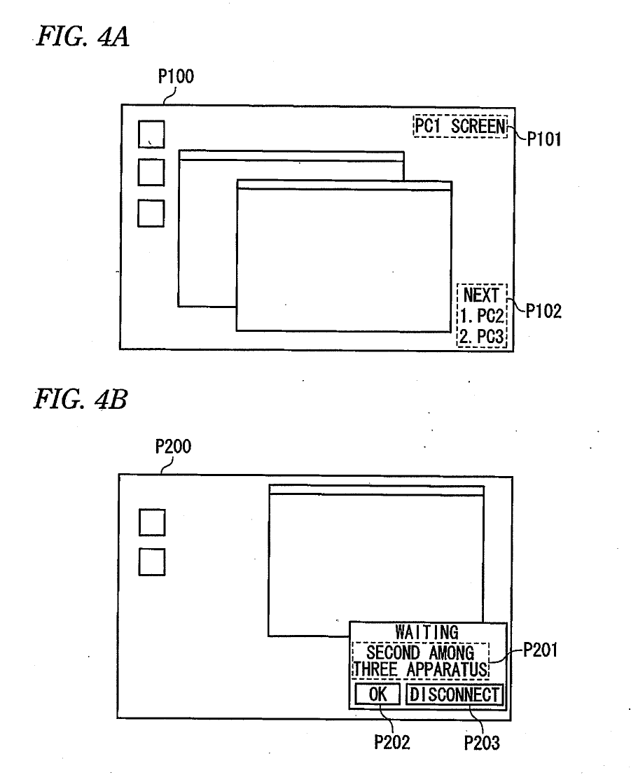

Next, example pictures which are displayed by the display apparatus 100 and each of the computers 300 to 500 will be described with reference to FIGS. 4A and 4B, respectively. FIG. 4A shows an example picture P100 which is displayed by the display apparatus 100. The picture P100 includes, in addition to the image of image data transmitted from one of the computers 300 to 500, images P101 and P102 of image data generated by the radio apparatus 200. The image P101 indicates the apparatus name or identifier of the computer which is sending the image data that are being received by the radio apparatus 200. The image P102 indicates the apparatus names or identifiers of computers that will be allowed to send image data after the computer that is sending the image data to the radio apparatus 200, that is, computers that stand at second and lower positions in the waiting list 2031.

FIG. 4B shows an example picture P200 which is displayed by each of the computers 300 to 500. The picture P200 is displayed by one of the computers 300 to 500 that has sent an image output permission request to the radio apparatus 200 and received waiting information without receiving a permission response in response to the request. The picture P200 includes pictures P201, P202, and P203. The image P201 indicates the order of the concerned computer among computers that are connected to the radio apparatus 200 and registered in the waiting list 2031. The images P202 and P203 are images for allowing the user to determine whether to continue or terminate the wireless communication between the concerned computer and the radio apparatus 200.

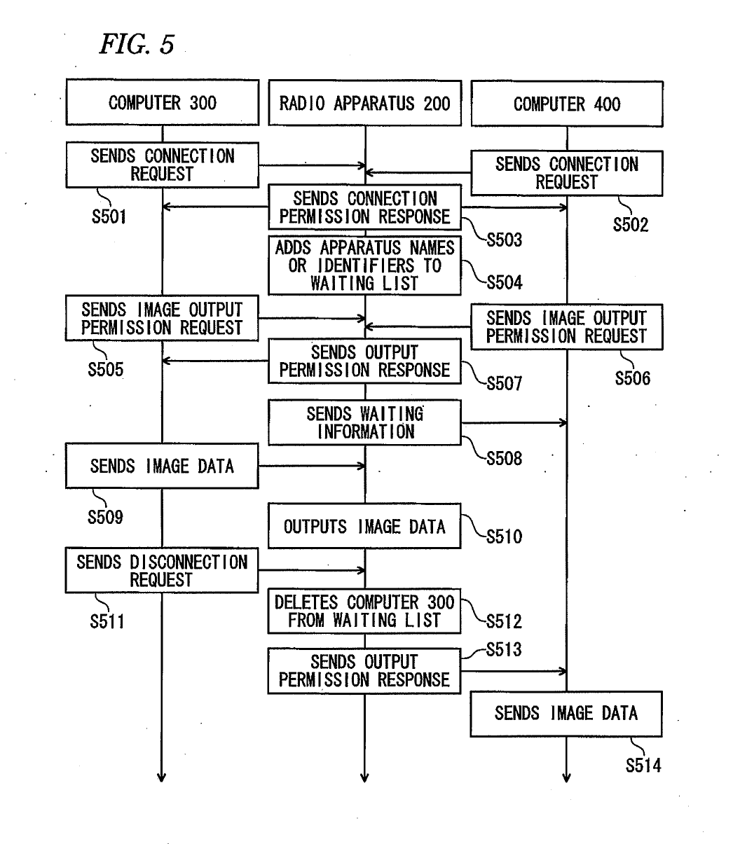

FIG. 5 is a sequence diagram of image data transmitting/receiving operations of the radio apparatus 200 and the computers 300 and 400.

First, at step S501, the computer 300 sends a communication connection request. Then, at step S502, the computer 400 sends a communication connection request. At step S503, the radio apparatus 200 sends connection permission responses to the respective computers 300 and 400. At step S504, the radio apparatus 200 registers, in the waiting list 2031, apparatus names or identifiers contained in the received connection requests. At steps S505 and S506, the radio apparatus 200 receives image output permission requests from the computers 300 and 400, respectively. At step S507, the radio apparatus 200 refers to the waiting list 2031 and sends an image output permission response to the computer 300 which stands at the head of the waiting list 2031. At step S508, the radio apparatus 200 sends waiting information to the computer 400 which does not stand at the head of the waiting list 2031.

Receiving the image output permission response, at step S509 the computer 300 sends image data to the radio apparatus 200. At step S510, the radio apparatus 200 outputs the received image data to the display apparatus 100. Receiving a manipulation input for stopping the transmission of the image data to the radio apparatus 200, at step S511 the computer 300 sends a communication disconnection request. Receiving the disconnection request, at step S512 the radio apparatus 200 updates the waiting list 2031 by deleting the computer 300 from the waiting list 2031. At step S513, the radio apparatus 200 sends an image output permission response to the computer 400 which stands at the head of the waiting list 2031. Receiving the output permission response, at step S514 the computer 400 sends image data to the radio apparatus 200.

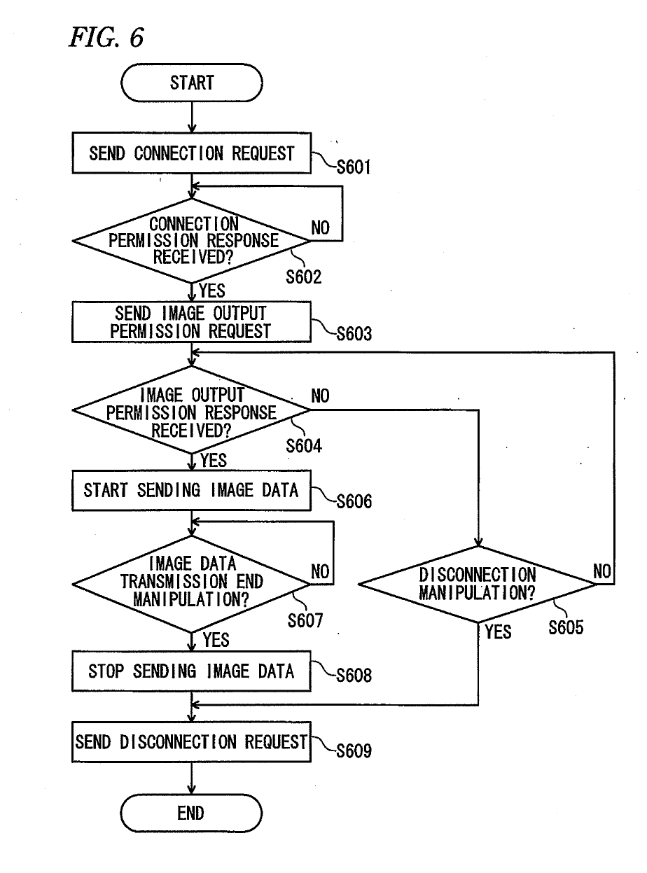

Next, an example image data transmission process which is performed by the computer 300 will be described with reference to a flowchart of FIG. 6. First, at step S601, the computer 300 sends a communication connection request to the radio apparatus 200. When receiving a connection permission response in response to the connection request (S602: yes), at step S603 the computer 300 sends an image output permission request to the radio apparatus 200.

When not receiving an image output permission response (S604: no), that is, when receiving waiting information, the computer 300 displays, for example, a picture as shown in FIG. 4B and thereby inquires of the user whether to disconnect the communication. When receiving a communication disconnection manipulation from the user (S605: yes), the process moves to step S609. On the other hand, when not receiving a communication disconnection manipulation from the user (S605: no), the process returns to step S604.

When receiving an image output permission response (S604: yes), at step S606 the computer 300 starts sending image data to the radio apparatus 200. When receiving an image data transmission end manipulation from the user (S607: yes), the computer 300 stops the transmission of the image data at step S608 and sends a communication disconnection request at step S609.

When receiving an image output permission response (S604: yes), the computer 300 may display a selection picture for inquiring of the user whether to send image data or a notification picture for notifying the user of upcoming transmission of image data. For example, the computer 300 may display the selection picture or the notification picture when the time from the transmission of the image output permission request to the reception of the image output permission response is longer than or equal to a certain time.

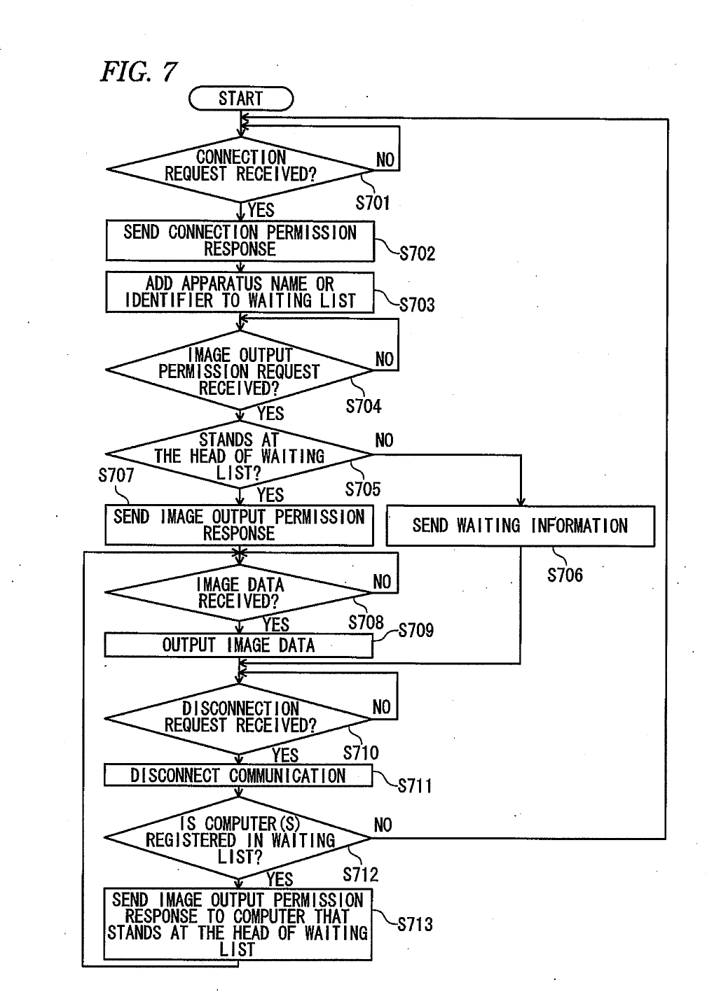

Next, an example image data reception process which is performed by the radio apparatus 200 will be described with reference to a flowchart of FIG. 7. First, when receiving a communication connection request from the computer 300, for example (S701: yes), the radio apparatus 200 determines at step S702 whether or not the number of computers that are currently connected wirelessly to the radio apparatus 200 is smaller than or equal to a certain number. When the number of computers that are currently connected wirelessly is smaller than or equal to the certain number, the radio apparatus 200 sends a connection permission response to the computer 300. At step S703, the radio apparatus 200 adds an apparatus name or identifier contained in the connection request to the waiting list 2031.

When receiving an image output permission request (704: yes), the radio apparatus 200 determines at step S705 whether or not the computer 300 which has sent the image output permission request stands at the head of the waiting list 2031. When the computer 300 does not stand at the head of the waiting list 2031 (S705: no), at step S706 the radio apparatus 200 sends waiting information to the computer 300. The process moves to step S710.

On the other hand, when the computer 300 which has sent the image output permission request stands at the head of the waiting list 2031 (S705: yes), at step S707 the radio apparatus 200 sends an image output permission response to the computer 300. When receiving image data (S708: yes), at step S709 the radio apparatus 200 outputs the received image data to the display apparatus 100.

When receiving a communication disconnection request from the computer 300 that transmitted the image data in step S708 (S710: yes), at step S711 the radio apparatus 200 disconnects the wireless communication by sending a disconnection response to the computer 300. At step S712, the radio apparatus 200 determines whether or not a computer(s) is registered in the waiting list 2031. When a computer(s) is registered in the waiting list 2031 (S712: yes), at step S713 the radio apparatus 200 sends an image output permission response to the computer that stands at the head of the waiting list 2031. The process returns to step S708. When no computer is registered in the waiting list 2031 (S712: no), the process returns to step S701.

Although the embodiment of the invention has been described above, the embodiment is only an example and should not be construed as restricting the scope of the invention. For example, the radio apparatus 200 may be incorporated in the cabinet of the display apparatus 100. In this case, the input module 101 of the display apparatus 100 and the output module 204 of the radio apparatus 200 are connected to each other by such an interface as an internal bus. The embodiment can be embodied in other various forms, and part of it can be omitted, replaced by other elements, or changed in various manners without departing from the spirit and scope of the invention. These modifications are included in the invention as claimed and its equivalents.

What is claimed is:

1. A radio apparatus comprising:
a first receiving module configured to receive a plurality of connection requests transmitted wirelessly from each of a plurality of external apparatuses;
a connection module configured to establish a plurality of communication connections with the external apparatuses by sending permission responses to the external apparatuses in response to the connection requests;
a register configured to register the external apparatuses in a chronological order corresponding to the order of establishment of each of the plurality of communication connections;
a selection module configured to select an external apparatus according to the chronological order; and
a second receiving module configured to receive image data that is transmitted from the selected external apparatus.

2. The radio apparatus according to claim 1, further comprising an output module configured to output the received image data to a display.

3. The radio apparatus according to claim 1, further comprising an output module configured to output to a display information relating to the external apparatuses registered by the register.

4. The radio apparatus according to claim 1, further comprising a third receiving module configured to receive a plurality of image output permission requests transmitted from each of the plurality of external apparatuses,
wherein the selection module is further configured to select an external apparatus from the plurality of external apparatuses according to the chronological order of the image output permission requests.

5. The radio apparatus of claim 4, further comprising a transmitting module configured to send to one or more of the plurality of external apparatuses, other than the selected external apparatus, pieces of information regarding an order of respective transmission source external apparatuses among the chronological order.

6. A display apparatus comprising:
a first receiving module configured to receive a plurality of connection requests transmitted wirelessly from each of a plurality of external apparatuses;
a connection module configured to establish a plurality of communication connections with the external apparatuses by sending permission responses to the external apparatuses in response to the connection requests;
a register configured to register the external apparatuses in a chronological order corresponding to the order of establishment of each of the plurality of communication connections;
a selection module configured to select an external apparatus according to the chronological order;
a second receiving module configured to receive image data that is transmitted from the selected external apparatus; and
a display configured to display the received image data.

7. A reception control method of a radio apparatus, comprising:
receiving a plurality of connection requests transmitted wirelessly from each of a plurality of external apparatuses;
establishing a plurality of communication connections with the external apparatuses by sending permission responses to the external apparatuses in response to the connection requests;
registering the external apparatuses in a chronological order according to the order of establishment of each of the plurality of communication connections;
selecting an external apparatus according to the chronological order; and
receiving image data that is transmitted from the selected external apparatus.
